(19) United States
(12) Patent Application Publication
(10) Pub. No.: US 2023/0306487 A1
(43) Pub. Date: Sep. 28, 2023

(54) INFORMATION PROVIDING APPARATUS, INFORMATION PROVIDING METHOD, AND INFORMATION PROVIDING SYSTEM

(71) Applicant: Riichiro Tsukamoto, Fujisawa-shi (JP)

(72) Inventor: Riichiro Tsukamoto, Fujisawa-shi (JP)

(21) Appl. No.: 18/321,398

(22) Filed: May 22, 2023

Related U.S. Application Data
(63) Continuation of application No. PCT/JP2021/040953, filed on Nov. 8, 2021.

(30) Foreign Application Priority Data
Nov. 24, 2020 (JP) 2020-194279

(51) Int. Cl. G06Q 30/0601; G06Q 50/12; G06Q 10/02

(52) U.S. Cl. CPC G06Q 30/0627; G06Q 10/02; G06Q 50/12

(57) ABSTRACT

An information providing apparatus includes a storage that stores a plurality of registered shop names and one or more registered beverage names in association with each other, an information acquisition part that acquires beverage name information indicating a beverage name input in a user terminal capable of communicating with the information providing apparatus, an identification part that identifies a registered shop name stored in the storage in association with the registered beverage name corresponding to the beverage name indicated by the beverage name information, and an information providing part that provides the user terminal with the shop name information indicating the registered shop name identified by the identification part.

### CROSS-REFERENCE TO RELATED APPLICATIONS

The present application is a continuation application of International Application number PCT/JP2021/040953, filed on Nov. 8, 2021, which claims priority under 35 U.S.C §119(a) to Japanese Patent Application No. 2020-194279, filed on Nov. 24, 2020, contents of which are incorporated herein by reference in their entirety.

### BACKGROUND OF THE INVENTION

The present disclosure relates to an information providing apparatus, an information providing method, and an information providing system for providing information about restaurants. Conventionally, a service for searching for restaurants has been known. Japanese Unexamined Patent Application Publication No. 2012-99095 discloses a technique for searching for restaurants using the date and time, the number of guests, and a budget of a party as search conditions.

When dining at restaurants, diners can order beverages. There are various brands of beverages, and whether one can have one of his/her favorite brands of beverages is an important factor for those who dine. However, when a restaurant is searched for and reserved on the basis of the date and time, the number of guests, and the budget, there are cases where guests are unhappy with the reserved restaurant because their desired beverage are not served there.

### BRIEF SUMMARY OF THE INVENTION

The present disclosure focuses on this point, and its object is to easily acquire information about shops that serve desired beverages.

An information providing apparatus according to a first aspect of the present disclosure is an information providing apparatus that provides shop name information, the information providing apparatus including: a storage that stores a plurality of registered shop names and one or more registered beverage names in association with each other; an information acquisition part that acquires beverage name information indicating a beverage name input in an information terminal capable of communicating with the information providing apparatus; an identification part that identifies the registered shop name stored in the storage in association with the registered beverage name corresponding to the beverage name indicated by the beverage name information; and an information providing part that provides the information terminal with the shop name information indicating the registered shop name identified by the identification part.

An information providing method according to a second aspect of the present disclosure is an information providing method, executed by a computer, for providing shop name information, the information providing method including: acquiring beverage name information indicating a beverage name input in an information terminal capable of communicating with the computer; identifying, by referencing a storage that stores a plurality of registered shop names and one or more registered beverage names in association with each other, the registered shop name stored in the storage in association with the registered beverage name corresponding to the beverage name indicated by the beverage name information; and providing the information terminal with the shop name information indicating the identified registered shop name.

An information providing system according to a third aspect of the present disclosure is an information providing system which includes an information providing apparatus that provides shop name information and an information terminal that receives the shop name information from the information providing apparatus. The information providing apparatus includes: a storage that stores a plurality of registered shop names and one or more registered beverage names in association with each other; an information acquisition part that acquires beverage name information indicating a beverage name input in an information terminal capable of communicating with the information providing apparatus; an identification part that identifies the registered shop name stored in the storage in association with the registered beverage name corresponding to the beverage name indicated by the beverage name information; and an information providing part that provides the information terminal with the shop name information indicating the registered shop name identified by the identification part, and the information terminal includes: a transmitting part that transmits the beverage name information indicating the beverage name input by a user of the information terminal to the information providing apparatus; and a display part that displays the shop name information received from the information providing apparatus.

### BRIEF DESCRIPTION OF THE DRAWINGS

FIG. 1 shows an outline of an information providing system.

FIG. 2 shows an example of a shop search screen.

FIG. 3 shows an example of a screen on which shop names are displayed.

FIG. 4 shows configurations of an information providing apparatus and a user terminal.

FIG. 5 shows an example of a shop database.

FIG. 6 shows an example of a database in which (i) registered shop names, (ii) the names of dishes served in each shop, and (iii) a time of year when the dishes are served are associated with each other.

FIG. 7 shows an example of a first database.

FIG. 8 shows an example of a second database.

FIG. 9 shows a flow of processing in the information providing system.

### DETAILED DESCRIPTION OF THE INVENTION

Hereinafter, the present disclosure will be described through exemplary embodiments, but the following exemplary embodiments do not limit the disclosure according to the claims, and not all of the combinations of features described in the exemplary embodiments are necessarily essential to the solution means of the disclosure.

### Outline of an Information Providing System S

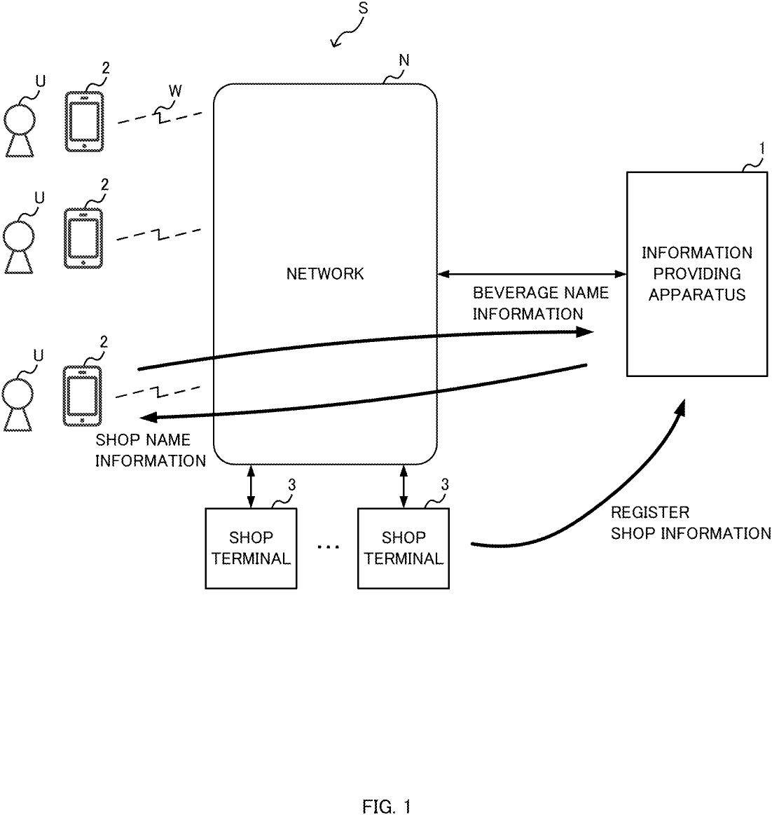

FIG. 1 shows an outline of an information providing system S. The information providing system S is a system for searching for restaurants such as bistros or fine restaurants. The information providing system S is characterized in that, when a user U who is looking for restaurants designates a beverage that he/she wishes to drink, information on restaurants where the designated beverage is served is provided to the user U.

The information providing system S includes an information providing apparatus 1, a plurality of user terminals 2, and a plurality of shop terminals 3. The information providing apparatus 1 is a server, for example, and provides information about restaurants to the user U. The information providing apparatus 1 transmits and receives various types of data to and from the plurality of user terminals 2 and the plurality of shop terminals 3 via a network N or a wireless communication line W. The network N includes the Internet or a mobile phone network, for example. The wireless communication line W is a Wi-Fi (registered trademark), for example.

The user terminal 2 and the shop terminal 3 are information terminals each having a communication function and a display function, and are smartphones, tablets, or computers, for example. The user terminal 2 is a terminal used by the user U who is looking for restaurants. The shop terminal 3 is a terminal used by an administrator or employee (hereinafter, referred to as a “staff member”) of a restaurant, who registers a shop name in the information providing apparatus 1.

A basic operation of the information providing system S will be described with reference to FIG. 1. First, a staff member of a restaurant who wishes to register a shop name in the information providing apparatus 1 transmits various types of information about the shop (hereinafter, referred to as “shop information”) to the information providing apparatus 1 using the shop terminal 3. The shop information is information about a shop name, an address of the shop, and dishes and beverages served in the shop. The staff member can newly register or update the shop information by entering a login ID and password assigned to the shop on a shop information registration screen displayed on the shop terminal 3, for example.

On the other hand, the user U looking for restaurants enters various conditions (hereinafter referred to as “search conditions”) for searching for shops in the user terminal 2. The user U can enter the search conditions by entering a login ID and password assigned to the user U on a shop search screen displayed on the user terminal 2, for example.

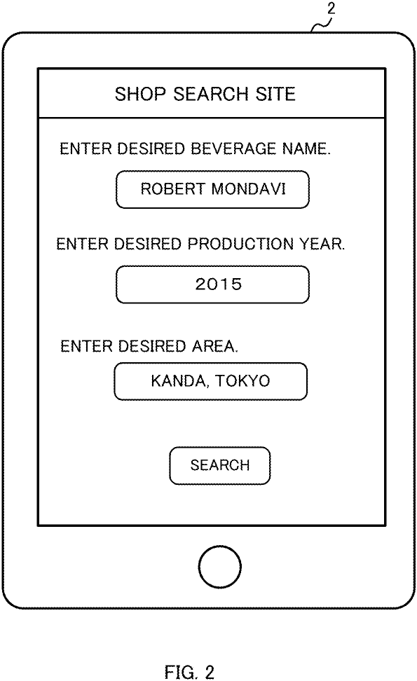

FIG. 2 shows an example of the shop search screen. In the shop search screen shown in FIG. 2, a screen for entering a beverage name, a production year of the beverage, and an area where a shop is located are displayed as the search conditions. When the user U enters the beverage name as one of the search conditions, the user terminal 2 transmits beverage name information indicating the beverage name to the information providing apparatus 1. In the example shown in FIG. 2, a beverage brand is entered as the beverage name, but a type of beverage such as wine, sake, or beer may be entered as the beverage name. By referencing a database in which a beverage name served in a shop is registered, the information providing apparatus 1 extracts a shop capable of serving the beverage indicated by the beverage name information received from the user terminal 2, and transmits shop name information indicating the name of the extracted shop to the user terminal 2. It should be noted that the user terminal 2 may display a screen for further entering the date and time of using a shop, a budget, the name of the desired dish, and the like as the search conditions. The name of the dish may be the name of a specific dish, a type of cuisine (Japanese cuisine, French cuisine, etc.), or identification information composed of numbers or alphabetic characters corresponding to a dish.

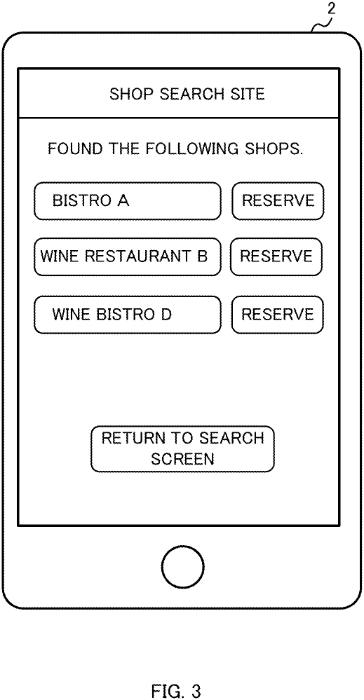

The user terminal 2 displays the shop name indicated by the shop name information received from the information providing apparatus 1. FIG. 3 shows an example of a screen on which shop names are displayed. When the user U taps the displayed shop name, the user terminal 2 displays detailed information about that shop. When the user U taps a “reservation” button, the user terminal 2 displays a screen for making a reservation at the selected shop. Hereinafter, configurations and operations of the information providing apparatus 1 and the user terminal 2 will be described in detail.

### Configurations of the Information Providing Apparatus 1 and the User Terminal 2

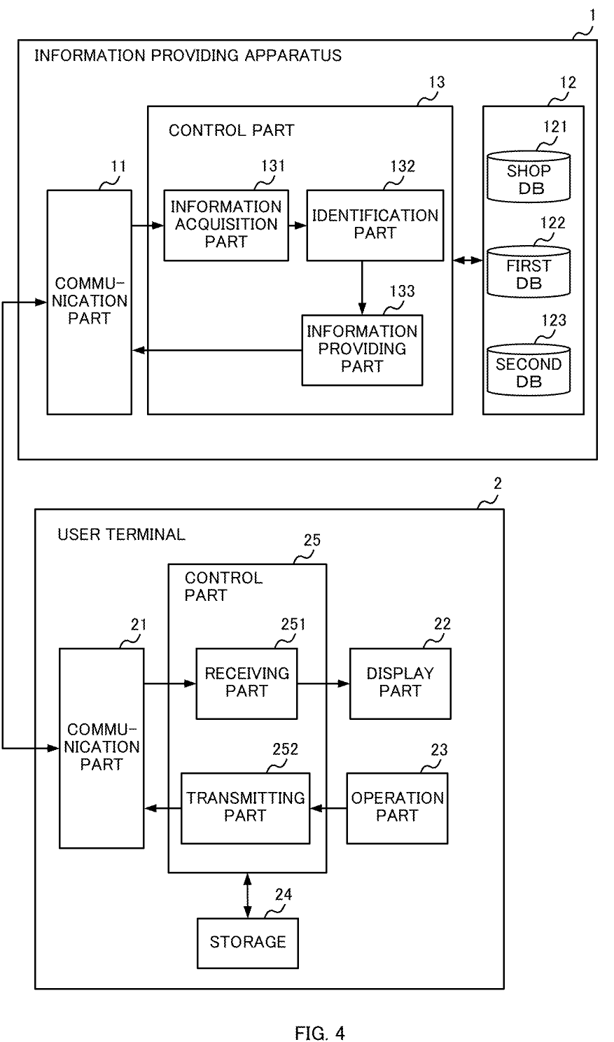

FIG. 4 shows configurations of the information providing apparatus 1 and the user terminal 2. The information providing apparatus 1 includes a communication part 11, a storage 12, and a control part 13. The control part 13 includes an information acquisition part 131, an identification part 132, and an information providing part 133.

The communication part 11 includes a communication interface for transmitting and receiving various types of data to and from the user terminal 2 and the shop terminal 3 via the network N. The communication part 11 inputs data received from the user terminal 2 or the shop terminal 3 to the information acquisition part 131. Further, the communication part 11 transmits data input from the information providing part 133 to the user terminal 2 or the shop terminal 3.

The storage 12 includes a storage medium such as a ROM (Read Only Memory), a RAM (Random Access Memory), and an SSD (Solid State Drive). The storage 12 stores a program executed by the control part 13. The storage 12 stores (i) a plurality of registered shop names and (ii) one or more registered beverage names, in association with each other. The storage 12 stores a shop database 121, a first database 122, and a second database 123 as various databases used by the control part 13 to search for shops. Details of the shop database 121, the first database 122, and the second database 123 will be described later.

The control part 13 includes a CPU (Central Processing Unit), and functions as the information acquisition part 131, the identification part 132, and the information providing part 133 by executing the program stored in the storage 12, for example. Details of the information acquisition part 131, the identification part 132, and the information providing part 133 will be described later.

Next, the user terminal 2 will be described. The user terminal 2 includes a communication part 21, a display part 22, an operation part 23, a storage 24, and a control part 25. The control part 25 includes a receiving part 251 and a transmitting part 252.

The communication part 21 has a communication interface for transmitting and receiving various types of data to and from the information providing apparatus 1 via the network N. The communication part 21 inputs data received from the information providing apparatus 1 to the receiving part 251. The data input from the transmitting part 252 is transmitted to the information providing apparatus 1.

The display part 22 is a display for the receiving part 251 to display information received from the information providing apparatus 1. The display part 22, for example, displays a screen for entering information necessary for the user U to search for shops, and displays the shop name information provided from the information providing apparatus 1.

The operation part 23 is a device for receiving a data input operation performed by the user U. The operation part 23 includes a touchscreen provided on the display part 22, for example. The operation part 23 notifies the transmitting part 252 about data input by the user U.

The storage 24 is a storage medium including a ROM and a RAM. The storage 24 stores a program executed by the control part 25.

The control part 25 includes a CPU, for example, and functions as the receiving part 251 and the transmitting part 252 by executing the program stored in the storage 24. The receiving part 251 receives the shop name information transmitted by the information providing apparatus 1, and causes the display part 22 to display the received shop name information. The transmitting part 252 transmits beverage name information indicating a beverage name input by the user U of the user terminal 2 to the information providing apparatus 1. Hereinafter, details of the information providing apparatus 1 will be described.

### Examples of Databases Included in the Information Providing Apparatus 1

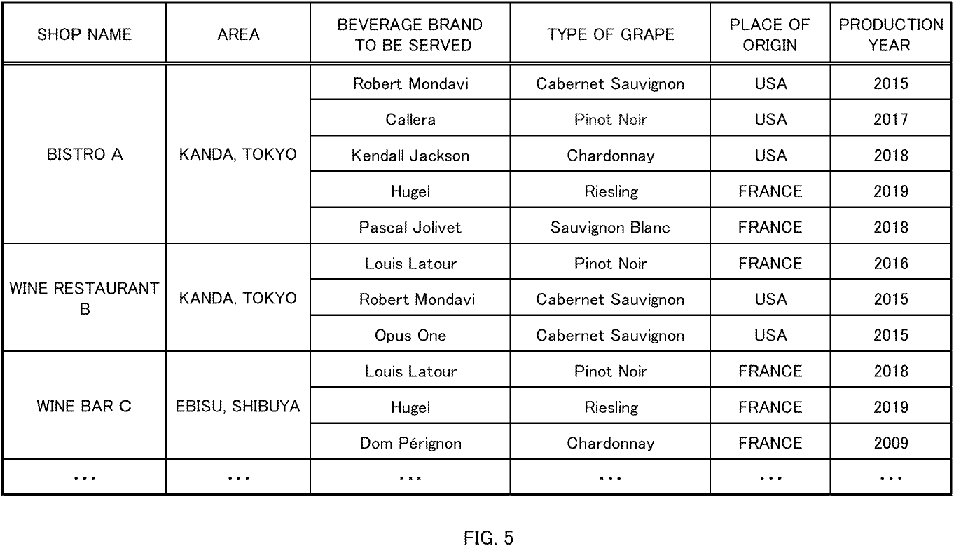

FIG. 5 shows an example of the shop database 121. The shop database 121 is a database in which (i) a beverage brand (that is, the registered beverage name) and (ii) the registered shop name of a shop at which said beverage brand is served are associated with each other. In the following description, a shop name registered in the database may be referred to as a “registered shop name”. In the shop database 121 shown in FIG. 5, (i) a shop name, (ii) an area where the shop is located, and (iii) information about a beverage that can be served in the shop are associated with each other. The information about the beverage includes a beverage name, a type of beverage, a place of origin of the beverage, and a production year of the beverage, for example.

A case where the beverage is wine is exemplified in the example shown in FIG. 5, but the beverage may be sake, beer, whiskey, brandy, shochu (Japanese distilled spirits), cocktails, non-alcoholic drinks, or the like. The type of grape is shown as the type of the beverage in FIG. 5, but other information may be used as long as it is information used to identify beverages. Further, the name of the country is registered as the place of origin, but the name of a region/district in the country may be registered.

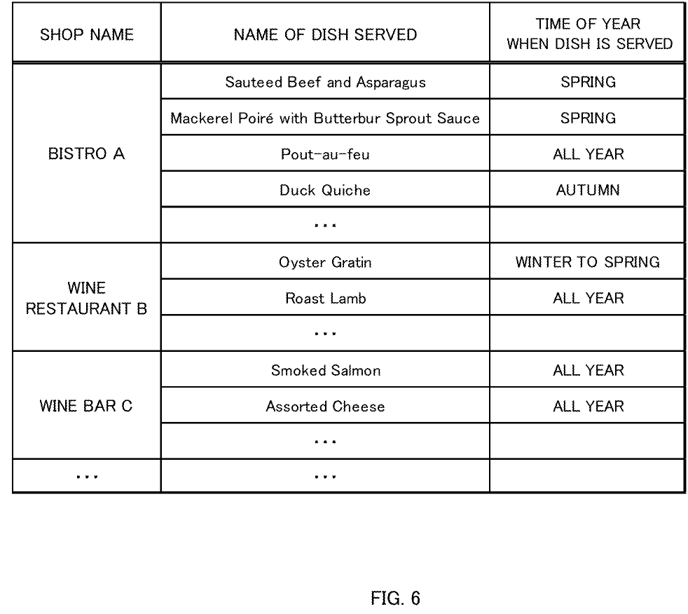

The shop database 121 may be a database in which the shop names are associated with the names of the dishes served in each shop. FIG. 6 shows an example of the shop database 121 in which (i) registered shop names, (ii) the names of dishes served in each shop, and (iii) a time of year when the dishes are served are associated with each other. The storage 12 may store, as the shop database 121, both the database shown in FIG. 5 and the database shown in FIG. 6.

The storage 12 may store (i) the registered shop name, (ii) the registered beverage name, and (iii) one or more registered dish names, in association with each other. In other words, the shop database 121 may be a database in which the registered shop name, the beverage brand that can be served in the shop, and the name of the dish that can be served in the shop are associated with each other.

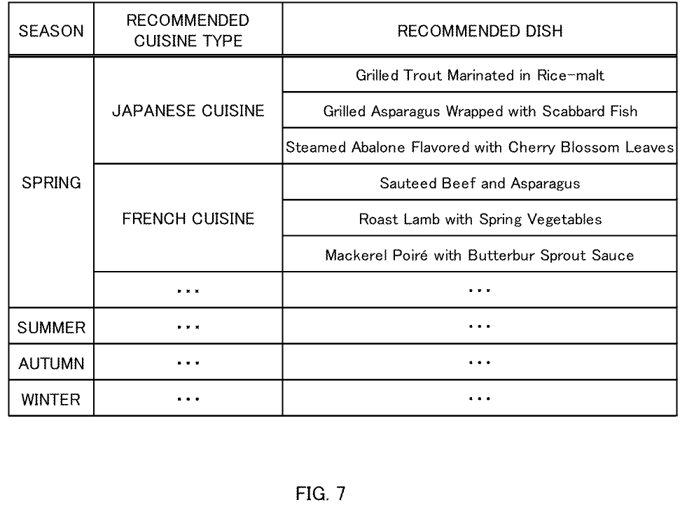

FIG. 7 shows an example of the first database 122. The first database 122 is a database in which (i) a time of year and (ii) the name of a recommended dish are associated with each other. In this way, the storage 12 may store (i) the registered dish name and (ii) a registered time period indicating a time period during which dishes related to the registered dish name are served, in association with each other. In the first database 122 shown in FIG. 7, each of several different seasons (e.g., spring, summer, autumn, and winter) and the names of the recommended dishes are associated with each other. As shown in FIG. 7, a type of cuisine, serving as the name of the recommended dish, may be associated with a time of year. The registered time period is not limited to four seasons, and may include date information.

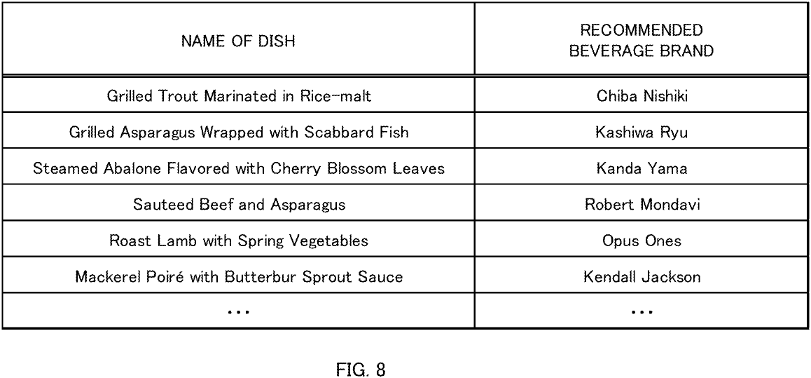

FIG. 8 shows an example of the second database 123. The second database 123 is a database in which (i) the name of a dish and (ii) a recommended beverage are associated with each other. In the second database 123 shown in FIG. 8, the names of the dishes and recommended beverage brands are associated with each other. In FIG. 8, one recommended beverage brand is associated with each dish, but a plurality of recommended beverage brands may be associated with each dish. Further, the names of the dishes and attributes of the recommended beverages may be associated with each other in the second database 123. The attributes of a beverage are its flavor or appearance characteristics. In a case where the beverage is wine, the attributes of the beverage are its color such as red, rosé, or white, the type of grape, or the like. In a case where the beverage is sake, the attributes of the beverage are its alcohol content, the type of sake brewing rice, or the like.

### Operation of the Control Part 13

Hereinafter, operations of the information acquisition part 131, the identification part 132, and the information providing part 133 included in the control part 13 will be described in detail. The information acquisition part 131 acquires beverage name information indicating the beverage name input in the user terminal 2 capable of communicating with the information providing apparatus 1 via the communication part 11. The information acquisition part 131 inputs the acquired beverage name information to the identification part 132. The beverage name information may be information indicating a beverage brand, identification information composed of numbers or letters such as alphabetic characters corresponding to the beverage brand, or information indicating the type of the beverage such as wine, sake, or beer.

The identification part 132 identifies a registered shop name which is stored in the storage 12 in association with the registered beverage name corresponding to the beverage name indicated by the beverage name information input from the information acquisition part 131. Specifically, the identification part 132 references the shop database 121 stored in the storage 12, and extracts one or more registered shop names to which a beverage name identical or similar to the beverage name indicated by the beverage name information is associated as the registered beverage name in the shop database 121. Even if the beverage name indicated by the beverage name information does not exactly match the registered beverage name, the identification part 132 extracts the registered shop name associated with the registered beverage name in the shop database 121 if a predetermined percentage (e.g., 90%) of the characters in the registered beverage name match the beverage name indicated by the beverage name information and this beverage name is determined to be similar to the registered beverage name. The identification part 132 inputs the identified registered shop name to the information providing part 133.

The information providing part 133 provides shop name information indicating the registered shop name identified by the identification part 132 to the user terminal 2 via the communication part 11, thereby causing the user terminal 2 to display the shop name capable of serving the beverage inputted by the user U. If the identification part 132 identifies a plurality of registered shop names, the information providing part 133 transmits shop name information including the plurality of registered shop names to the user terminal 2.

The basic function of the information providing apparatus 1 has been described above. In order to identify a beverage, the information providing apparatus 1 can use various elements other than the beverage name, such as a place of origin, raw materials, a production year, and an affinity of a wine with a dish. For example, in a case where the beverage is wine, its taste varies depending on the place of origin, the type of grape, and the production year. Further, the affinity with a dish varies depending on the type and brand of the wine. For this reason, the information acquisition part 131 may acquire at least one of these various elements, and the identification part 132 may identify a shop name suitable for the user U on the basis of the element acquired by the information acquisition part 131.

For example, the information acquisition part 131 further acquires production year information indicating the year of the production input in the user terminal 2, and the identification part 132 identifies a registered shop name stored in the storage 12 in further association with the production year indicated by the production year information. As shown in FIG. 2, in a case where the user U enters a production year in addition to a brand of wine, the identification part 132 identifies a shop name registered in the shop database 121 in association with a wine corresponding to the entered production year among a plurality of wines of the same brand but different production years. By having the identification part 132 identify the shop name on the basis of the production year of the beverage in this way, the user U can find a shop that will serve the beverage of the production year he/she wishes to drink.

The information acquisition part 131 may further acquire place-of-origin information indicating the name of a place of origin input in the user terminal 2, and the identification part 132 may identify a registered shop name stored in the storage 12 in association with the name of a place of origin indicated by the place-of-origin information. When the user U enters “wine” as the beverage name, “Chardonnay” as the type of grape, and “USA” as the name of the place of origin, by referencing the shop database shown in FIG. 5, the identification part 132 selects “Bistro A” capable of serving “Kendall Jackson,” for example.

If there are a plurality of beverages that satisfy the conditions regarding the name of the place of origin, the identification part 132 selects a plurality of registered shop names associated with each of the beverages, and the information providing part 133 provides a plurality of shop names to the user terminal 2. Since the identification part 132 identifies the shop name on the basis of the name of a place of origin in this way, even if the user U does not remember the beverage brand, he/she can find a shop that will serve his/her desired beverage.

The information acquisition part 131 may further acquire dish name information indicating the dish name input in the user terminal 2, and the identification part 132 may identify a registered shop name stored in the storage 12 in further association with the registered dish name corresponding to the dish name indicated by the dish name information. Specifically, in the shop database 121 shown in FIG. 6, the identification part 132 identifies a shop name associated with a dish name identical or similar to the dish name input by the user U. By referencing the plurality of shop databases shown in FIGS. 5 and 6, the identification part 132 may identify a shop that serves both the beverage and the dish desired by the user U. Since the identification part 132 operates in this manner, the user U can find a shop that will serve his/her desired beverage and dish.

The identification part 132 may identify a registered dish name stored in the storage 12 in association with the registered beverage name corresponding to the beverage name indicated by the beverage name information acquired by the information acquisition part 131. By referencing the database shown in FIG. 8, the identification part 132 identifies a dish name that goes well with the beverage indicated by the beverage name input by the user U, for example. The information providing part 133 may provide the user terminal 2 with information indicating the registered dish name identified by the identification part 132, together with the shop name information identified by the identification part 132. Since the identification part 132 and the information providing part 133 operate in this way, the user U can be made aware of a dish that goes well with the beverage which is served in the shop that serves his/her desired beverage. Since such information is provided to the user terminal 2, even if there are a plurality of shops which can serve the beverage desired by the user U, the user U can narrow down the shops on the basis of the dish served there.

The identification part 132 may identify a registered shop name stored in the storage 12 in association with (i) a registered time period including a point in time at which the information acquisition part 131 acquired the dish name information and (ii) the registered dish name corresponding to the dish name indicated by the dish name information. By referencing the database shown in FIG. 6, the identification part 132 identifies a shop capable of serving a dish identical or similar to the dish name input in the time of year when the user U tries to search for a shop by inputting the dish name, for example. Since the identification part 132 operates in this way, even if dishes to be served differ depending on the time of year, it is possible to find a shop that serves the desired dish and beverage during the time of year when the user U is looking for the shop.

The information providing apparatus 1 may identify a combination of a dish and a beverage recommended during a time of year when the user U searches for shops by inputting a beverage name, and may provide the user terminal 2 with information about the shop capable of serving said dish and beverage. In this case, the information acquisition part 131 acquires information indicating the type of beverage (e.g., wine, beer, etc.) as the beverage name information.

The identification part 132 identifies a name of the recommended dish associated with a time of year that includes a point in time at which the information acquisition part 131 acquired the beverage name information in the first database 122. Further, the identification part 132 identifies a recommended beverage associated with the identified name of the recommended dish, among the types of beverages indicated by the beverage name information (i.e., the beverage corresponding to the beverage name input by the user U as the search conditions), in the second database 123. The identification part 132 identifies a registered shop name associated with the beverage brand corresponding to the recommended beverage in the shop database 121. The information providing part 133 provides shop name information indicating the registered shop name identified by the identification part 132 to the user terminal 2.

As an example, suppose that the user U searched for a shop name around March by inputting “wine” as the beverage name information. In this case, the identification part 132 identifies a dish name which is recommendable for spring by referencing the first database 122 shown in FIG. 7. Subsequently, the identification part 132 identifies a beverage brand that goes well with the recommendable dish by referencing the second database 123 shown in FIG. 8.

Further, the identification part 132 identifies a shop capable of serving the identified dish and the identified beverage brand by referencing the shop database 121 shown in FIGS. 5 and 6. Since the information providing apparatus 1 provides information about the shop identified in this manner, simply by inputting his/her desired type of beverage, the user U can find a shop that serves the dishes recommended in that time of year and the beverage that he/she wishes to drink and goes well with those dishes.

### Modified Example

In the above description, an area for which the information providing apparatus 1 provides information is not considered, but by using a database corresponding to each of a plurality of areas, the information providing apparatus 1 may provide the user terminal 2 with information about a shop that serves a beverage corresponding to a beverage name input by the user U in an area selected by the user U. The information providing apparatus 1 may provide a shop information providing site for Shibuya Ward, a shop information providing site for Minato Ward, and a shop information providing site for Fujisawa City for example. In this case, the information providing apparatus 1 may automatically identify an area including a location of the user terminal 2 at a point in time when the beverage name information is acquired from the user terminal 2, and may provide the user terminal 2 with information about the shop in the identified area.

### Processing Flow in the Information Providing System S

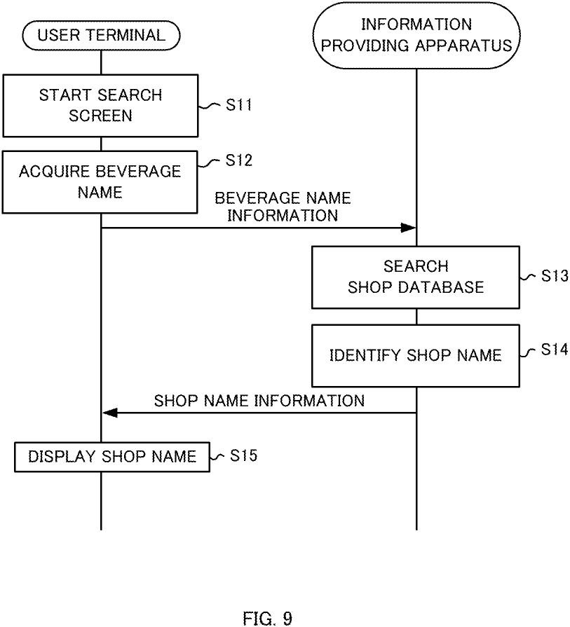

FIG. 9 is a flowchart showing processing in the information providing system S. When the user U logs in to a site for searching shops to start a search screen (S11), the user terminal 2 acquires a beverage name entered by the user U (S12). The user terminal 2 transmits beverage name information indicating the acquired beverage name to the information providing apparatus 1.

The information providing apparatus 1 searches the shop database 121 on the basis of the received beverage name information (S13). By referencing the shop database 121, the identification part 132 identifies a shop name associated with the beverage name indicated by the beverage name information (S14). The information providing part 133 transmits shop name information indicating the shop name identified by the identification part 132 to the user terminal 2. Upon receiving the shop name information, the information providing apparatus 1 causes the display part 22 to display the received shop name information (S15).

### Effect of the Information Providing System S

As described above, the information providing apparatus 1 includes: the identification part 132 that identifies the shop name stored in the storage 12 in association with the registered beverage name corresponding to the beverage name input by the user U, and the information providing part 133 that provides information indicating the shop name identified by the identification part 132 to the user terminal 2. Since the information providing apparatus 1 has such a configuration, the user U can easily find the shop that serves his/her desired beverage simply by inputting the information about the beverage.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiment.

What is claimed is:

1. An information providing apparatus that provides shop name information, the information providing apparatus comprising:
a storage that stores a plurality of registered shop names and one or more registered beverage names in association with each other;
an information acquisition part that acquires beverage name information indicating a beverage name input in an information terminal capable of communicating with the information providing apparatus;
an identification part that identifies the registered shop name stored in the storage in association with the registered beverage name corresponding to the beverage name indicated by the beverage name information; and
an information providing part that provides the information terminal with the shop name information indicating the registered shop name identified by the identification part.

2. The information providing apparatus according to claim 1, wherein
the storage stores the registered shop name and the name of a place of origin of the registered beverage name in association with each other,
the information acquisition part further acquires place-of-origin information indicating the name of a place of origin input in the information terminal, and
the identification part identifies the registered shop name stored in the storage in further association with the name of a place of origin indicated by the place-of-origin information.

3. The information providing apparatus according to claim 1, wherein
the storage stores the registered shop name and a production year of the registered beverage name in association with each other,
the information acquisition part further acquires production year information indicating a production year input in the information terminal, and
the identification part identifies the registered shop name stored in the storage in association with the production year indicated by the production year information.

4. The information providing apparatus according to claim 1, wherein
the storage stores the plurality of registered shop names and one or more registered dish names in association with each other;
the information acquisition part further acquires dish name information indicating a dish name input in the information terminal, and
the identification part identifies the registered shop name stored in the storage in association with the registered dish name corresponding to the dish name indicated by the dish name information.

5. The information providing apparatus according to claim 4, wherein
the storage stores (i) the registered dish name and (ii) a registered time period indicating a time period during which dishes related to the registered dish name are served, in association with each other, and
the identification part identifies the registered shop name stored in the storage in association with (i) the registered time period including a point in time at which the information acquisition part acquired the dish name information and (ii) the registered dish name corresponding to the dish name indicated by the dish name information, in association with each other.

6. The information providing apparatus according to claim 4, wherein
the identification part identifies, by referencing the storage, the registered shop name capable of serving a dish whose dish name is identical or similar to the dish name corresponding to the dish name information in a time of year when the information acquisition part acquired the dish name information.

7. The information providing apparatus according to claim 1, wherein
the storage stores the registered beverage name and one or more registered dish names in association with each other,
the identification part identifies the registered dish name stored in the storage in association with the registered beverage name corresponding to the beverage name indicated by the beverage name information acquired by the information acquisition part, and
the information providing part provides the information terminal with information indicating the registered dish name identified by the identification part, together with the shop name information identified by the identification part.

8. The information providing apparatus according to claim 1, wherein
the storage stores a first database in which a time of year and the name of a recommended dish are associated with each other, a second database in which a dish name and a recommended beverage are associated with each other, and a shop database in which the registered shop name, a beverage brand which can be served in a shop, and
a dish name which can be served in a shop are associated with each other,
the information acquisition part acquires information indicating a type of beverage as the beverage name information,
the identification part:
identifies the name of the recommended dish associated with the time of year that includes a point in time at which the information acquisition part acquired the beverage name information in the first database,
identifies the recommended beverage associated with the identified name of the recommended dish, among the types of beverages indicated by the beverage name information, in the second database, and
identifies the registered shop name associated with the beverage brand corresponding to the recommended beverage in the shop database, and the information providing part provides the information terminal with shop name information indicating the registered shop name identified by the identification part.

9. The information providing apparatus according to claim 8, wherein
the identification part identifies the recommended beverage that goes well with the identified name of the recommended dish.

10. An information providing method, executed by a computer, for providing shop name information, the information providing method comprising:
acquiring beverage name information indicating a beverage name input in an information terminal capable of communicating with the computer;
identifying, by referencing a storage that stores a plurality of registered shop names and one or more registered beverage names in association with each other, the registered shop name stored in the storage in association with the registered beverage name corresponding to the beverage name indicated by the beverage name information; and
providing the information terminal with the shop name information indicating the identified registered shop name.

11. An information providing system which includes an information providing apparatus that provides shop name information and an information terminal that receives the shop name information from the information providing apparatus, wherein the information providing apparatus includes:
a storage that stores a plurality of registered shop names and one or more registered beverage names in association with each other;
an information acquisition part that acquires beverage name information indicating a beverage name input in an information terminal capable of communicating with the information providing apparatus;
an identification part that identifies the registered shop name stored in the storage in association with the registered beverage name corresponding to the beverage name indicated by the beverage name information; and
an information providing part that provides the information terminal with the shop name information indicating the registered shop name identified by the identification part, and
the information terminal includes:
a transmitting part that transmits the beverage name information indicating the beverage name input by a user of the information terminal to the information providing apparatus; and
a display part that displays the shop name information received from the information providing apparatus.
